(19) United States
(12) Patent Application Publication
(10) Pub. No.: US 2004/0234928 A1
(43) Pub. Date: Nov. 25, 2004

(54) Base material for prosthesis

(75) Inventors: Sueo Saito, Tokyo (JP); Tetsuro Sakuma, Tokyo (JP); Futoshi Fusejima, Tokyo (JP); Toshihiro Sekiguchi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: GC Corporation, Tokyo (JP)

(21) Appl. No.: 10/847,349

(22) Filed: May 18, 2004

(30) Foreign Application Priority Data
May 22, 2003 (JP) 2003-144859

(51) Int. Cl. A61C 13/08

(52) U.S. Cl. 433/202.1; 433/212.1

(57) ABSTRACT

To provide a base material for a prosthesis having abrasion resistance and aesthetic appreciation more than equivalent to those of a conventional artificial tooth and to make a bridge and an artificial tooth for a partial denture easily in a short time without cutting adjacent teeth, the base material is made of a resin material, and comprises only a part having a form approximating to a lingual side surface part of the teeth being at the oral cavity side from a mucous of a dental cervix, two to four teeth may be connected, a thickness of the lingual side surface part is 0.5 mm or more from the lingual side surface and less than 0.5 mm from a labial surface of a teeth form being made finally, a surface contacting with a mucous surface of the dental cervix is formed and an engaging part connecting with a resin material built on a labial side surface is formed.

### BACKGROUND OF THE INVENTION

Field of the Invention

The present invention relates to a base material for a prosthesis having abrasion resistance and aesthetic appreciation more than equivalent to those of a conventional artificial tooth, wherein the base material for a prosthesis is used for directly forming a bridge in a short time by adhering with adjacent teeth with an adhesive material made with resin without cutting the adjacent teeth, and for easily making an artificial tooth used for a partial denture suiting to a lacked tooth part of a patient.

Conventionally, in the case that the tooth is lost in the state where the adjacent teeth exist at both sides but a dental root does not exist, following treating methods have been carried out, that is, the method, in which the partial denture corresponding to a part, where a tooth is lost, is made to be put on said part, and the method, in which a dental prosthesis modeling a dental form, which is called as the bridge, is made outside an oral cavity to be fixed at the treating part through the adjacent teeth of the patient. As the method for putting the partial denture, the method for cutting the adjacent teeth and fitting a retaining equipment, which is called as a clasp, projected at both sides of a denture base and has resiliency, to the adjacent teeth, has been used in general. As the method for fixing the bridge, the treating method for adhering to fix the bridge at a retainer formed by widely cutting the adjacent teeth has been carried out widely. In this method for fixing the bridge, in the case of requiring the aesthetic appreciation approximating to the natural tooth, the bridge, such as a resin faced bridge, a porcelain baked bridge, an all ceramics bridge or the like, has been used.

In the treating method for making the partial denture and putting it, an operator is required to form a part for locking the clasp at the adjacent teeth at both sides before making the partial denture. Since the part for locking the clasp is the part, in which the clasp of the partial denture is directly locked, the operation for forming said part for locking the clasp should be carefully carried out while considering the form and structure of the partial denture being made after, thus the skill and time have been required in said operation.

After forming the part for locking the clasp in this way, the images of the part including said part for locking the clasp (a negative mold of the tooth) are obtained from the inside of the oral cavity of the patient, and further, a gypsum model (a reproduction of the tooth) is made with said images. Then, the partial denture is made by the following process, based on said gypsum model.

The partial denture is completely made, by the steps of building a gingival part adjusted to the form in the oral cavity of the patient with a wax material on the gypsum model, piercing said gingival part to form a clasp at its both sides, arranging the suitable artificial tooth at the oral cavity side of the gingival part, setting the gypsum model in a dental flask, pouring gypsum into the oral cavity side of the gypsum model to hold the artificial tooth, taking said flask into an electric furnace after the gypsum having hardened, burning a wax pattern by heating to obtain a mold, pouring resin for a denture base into the mold to form the gingival part, and cutting and polishing the gingival part after digging out of the gypsum.

As for the making work of the partial denture, the form in the oral cavity, the making part, and the size and color tone of the tooth are different by every patient, and said work is the complicated work in which the very high dimensional accuracy in several μm unit is required, thus the time and skill have been needed so much. Especially, since the artificial tooth has very many kinds, in which the shape, the size and the color tone are different, the time and experience have been needed so much in order to choose what kinds of the artificial teeth to be used. In addition, as for the making work of the partial denture, since a treatment period until the partial denture being finally mounted inside the oral cavity of the patient is long, the patient has been forced to bear the high cost and burden. Further, in the case of the treating method for mounting the partial denture, it is necessary to cut some parts of the adjacent teeth even if those teeth are healthy, thus there is a problem that the burden on the patient is large. Further, the making work of the dental prosthesis is carried out by an indirect method, that is, the dental prosthesis is made in a dental mechanic or the like, which is different from the place of carrying out the treatment, such as a dental clinic or the like, there is a problem that the color tone of the made partial denture does not suit completely with that of the adjacent teeth, or the like.

Next, in the case of the treating method with the bridge, an operator is required to cut the adjacent teeth with a turbine to make a form approximating to a head-cut conical form before making the dental prosthesis called as the bridge, in order to use the adjacent teeth having the almost perfect form as the retainer. Since the retainer is the part adhered and fixed directory with the dental prosthesis, the operation for forming said retainer should be carefully carried out while considering the form and structure of the dental prosthesis being made after, thus the skill and time were required in said operation.

After forming the retainer in this way, the images of the part including said retainer (a negative mold of the tooth) are obtained from the inside of the oral cavity of the patient, and further, a gypsum model (a reproduction of the tooth) is made with said images. Then, the dental prosthesis is made by the following process, based on said gypsum model.

In the cases of the resin faced bridge and the porcelain baked bridge, these bridges are made by a lost wax casting method, comprising the steps of making a wax pattern of a core part on the gypsum model by using wax, investing the wax pattern in a refractory investment material, taking the refractory investment material into an electric furnace after said refractory investment material having hardened, burning the wax pattern by heating to obtain the mold, casting a metal in the obtained mold, digging out the casting material from the refractory investment material, cutting and polishing said casting material to make a metal core part, and building up and polymerizing a hard resin for a crown or building up and baking a porcelain on the outer surface of the metal core part. Further, in the case of the all ceramics bridge, said bridge is made by the steps of making a double model by using a refractory modeling material, building up and baking the porcelain on said double model, removing a refractory double model and carrying out shape modification and polishing.

In the case of the treating method with the bridge, the form in the oral cavity and making part are different by every patient, and said work is the complicated work in which the very high dimensional accuracy in several μm unit is required, thus the time and skill have been needed so much. In addition, since a treatment period until the dental prosthesis being finally fixed in the oral cavity of the patient is long, the patient has been forced to bear the high cost and burden. Further, the making work of the dental prosthesis is carried out by an indirect method, that is, the dental prosthesis is made in a dental laboratory or the like, which is different from the place carrying out the treatment, such as a dental clinic or the like, thus it was the present condition that the dental prosthesis having perfect accuracy is hardly obtained even when it is made by an expert. Further, it is necessary to cut some parts of the adjacent teeth even if those teeth are healthy, thus the burden on the patient is large. Further, since the dental prosthesis is made by the indirect method using the ready-made artificial tooth, there is a problem that the color tone of the made dental prosthesis does not suit completely with that of the adjacent teeth, or the like.

In this way, in the conventional treating method of the case, in which the tooth is lost, there are problems that the making of the dental prosthesis takes time and has trouble, and the color tone does not suit since it is made by the indirect method, and further, the cutting of some of the adjacent teeth is necessary even if they are healthy.

Then, the present invention has the object to solve the conventional problems and to provide the base material for a prosthesis to be used, in the case that the tooth is lost in the sate where the dental root is not existed, for making the prosthesis for the bridge capable of forming the dental prosthesis having the same color tone as that of the adjacent teeth in a short time only in the treating place without such works as cutting the healthy adjacent teeth at its both sides, making the gypsum model obtained by images, and indirectly making the dental prosthesis outside the oral cavity. Further, said base material for a prosthesis is used for easily making the artificial tooth, which is used to the partial denture suiting to the lacked tooth part of the patient, to have the shape and color tone suiting to the patient.

### SUMMARY OF THE INVENTION

The earnest work has been carried out in order to solve the above-mentioned problems and, as the result, the following investigation was carried out to complete the present invention about a base material for a prosthesis. That is, in the base material, which is made of a resin material and comprises only a part having the form approximating to a lingual side surface part of a tooth being at the oral cavity side from a mucous at a dental cervix, when a photopolymerizable or ordinary temperature polymerizable resin material, such as dental composite resin, is used to parts corresponding to adjacent surface parts and a labial side (buccal side) surface part of the base material, an artificial tooth having the form and color tone suitable to a patient can be easily made, and when this artificial tooth is made in the oral cavity to be adhered and fixed at the adjacent surfaces of the adjacent teeth, the bridge can be directly made in a short time only in the treating place, without cutting the healthy adjacent teeth to carefully form the retainer while considering the form and structure of the dental prosthesis being made after, as done conventionally, without making the gypsum model obtained by images, and without indirectly making the dental prosthesis outside the oral cavity. Further, in the case of the partial denture, the artificial tooth having the form and color tone suitable to the patient can be easily made.

That is, the present invention relates to a base material for the prosthesis, wherein said material is made of a resin material, and comprises only a part having the form approximating to a lingual side surface part of the teeth being at the oral cavity side from a mucous at a dental cervix. Further, said base material for a prosthesis is more preferable to have the shapes, in which two to four teeth are connected, a thickness of the lingual side surface part is 0.5 mm or more from the lingual side surface and less than 0.5 mm from the labial surface of the teeth form finally made, a surface contacting with the mucous surface of the dental cervix is formed, and an engaging part connecting with a resin material built on the labial side surface is formed.

### BRIEF EXPLANATION OF DRAWINGS

FIG. 1 is a perspective view of example 1 of the base material for a prosthesis for using an anterior tooth according to the present invention, being shown from the lingual side surface side.

FIG. 2 is a perspective view of example 1 of the base material for a prosthesis for using a conine according to the present invention, being shown from the lingual side surface side.

FIG. 3 is a perspective view of example 1 of the base material for a prosthesis for using a different anterior tooth from FIG. 1 according to the present invention, being shown from the labial side surface side.

FIG. 4 is a front view of example 1 of the base material for a prosthesis according to the present invention, being shown from the labial side surface side, where two teeth for anterior teeth are connected.

FIG. 5 is the front view of example 1 of the base material for a prosthesis according to the present invention, being shown from the lingual side surface side, where two teeth of an anterior tooth and a conine are connected.

FIG. 6 is the perspective view of example 1 of the base material for a prosthesis according to the present invention, being shown from the labial side surface side, where said base material is used for an anterior tooth different from FIGS. 1 and 3.

### EXPLANATION OF CODES

1 is a base material for a prosthesis.

1a is a labial side surface.

1b is an engaging part.

1c is a surface contacting with a mucous surface of a dental cervix.

### DETAILED DESCRIPTION OF PREFERRED EMBODIMENT

Hereinafter, the base material for a prosthesis according to the present invention will be explained concretely with drawings.

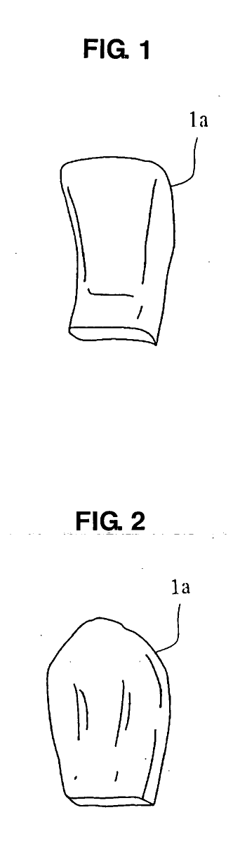

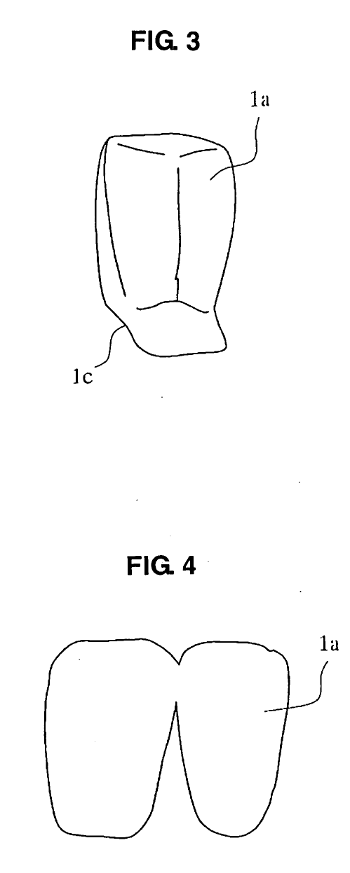

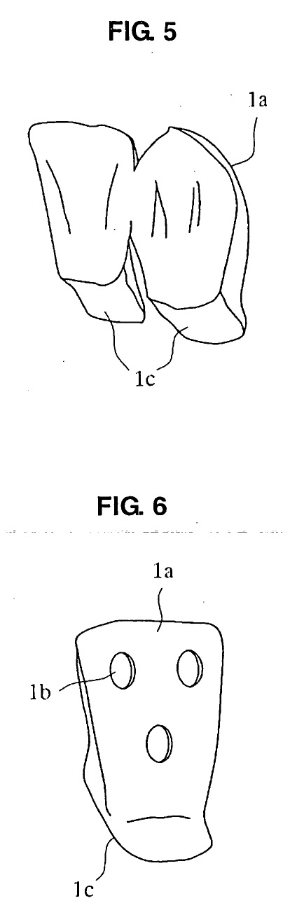

FIG. 1 is a perspective view of example 1 of the base material for a prosthesis for using an anterior tooth according to the present invention, being shown from the lingual side surface side. FIG. 2 is a perspective view of example 1 of the base material for a prosthesis for using a conine according to the present invention, being shown from the lingual side surface side. FIG. 3 is a perspective view of example 1 of the base material for a prosthesis for using a different anterior tooth from FIG. 1 according to the present invention, being shown from the labial side surface side. FIG. 4 is an anterior view of example 1 of the base material for a prosthesis according to the present invention, being shown from the labial side surface side, where two teeth for anterior teeth are connected. FIG. 5 is the front view of example 1 of the base material for a prosthesis according to the present invention, being shown from the lingual side surface side, where two teeth of an anterior tooth and a conine are connected. FIG. 6 is the perspective view of example 1 of the base material for a prosthesis according to the present invention, being shown from the labial side surface side, where said base material is used for an anterior tooth different from FIGS. 1 and 3.

In drawings, FIG. 1 is the base material for a prosthesis according to the present invention, which is made of a resin material. The resin material generally comprises a polymer being a mixture of a polymerizable compound having an unsaturated double bond and a polymerization initiator, and further, a filler may be included in said material. Although the conventional material for an artificial tooth can be used without limitation, when the filler is included in the resin material, said resin material is the same material as the conventional dental resin material called as the hard resin, thus the conventional characteristics of the hard resin tooth, that is, high abrasion resistance and aesthetic appreciation can be obtained.

The base material for a prosthesis 1 according to the present invention comprises only a part having the form approximating to the lingual side surface part of the teeth being at the oral cavity side from the mucous of the dental cervix, and said base material is made in the form of the artificial tooth, by building and hardening the photopolymerizable or ordinary temperature polymerizable resin material, which is the same material as the resin material comprising the base material for a prosthesis 1 according to the present invention, on the labial side (buccal side) surface part 1a. As the shape of said base material, for example, there are various shapes such as shapes for an anterior tooth as shown in FIGS. 1, 3, 4 and 6, a shape for a conine as shown in FIG. 2, and shapes in which two to four teeth are connected as shown in FIGS. 4 and 5.

In these various shapes, it is preferable that the thickness of the base material for a prosthesis 1 according to the present invention is 0.5 mm or more from the lingual side surface and less than 0.5 mm from the labial surface of the teeth form being made finally. By building the resin material such as the composite resin or the like, said base material can have the desired form and have the sufficient strength for carrying out the work after this. As the result, by building and hardening the photopolymerizable or ordinary temperature polymerizable resin material on the labial side (buccal side) surface part 1a, which is the same material as the resin material comprising the base material for a prosthesis 1 according to the present invention, said base material can be easily made in the form of the artificial tooth, in which the color tone is adjusted and suited with that of the adjacent teeth according to the necessity. If the thickness of the base material for a prosthesis 1 is less than 0.5 mm from the lingual side surface, the strength becomes to be insufficient. If said thickness is 0.5 mm or more from the labial surface of the teeth form being made finally, the color tone of the tooth is difficultly suited with that of the adjacent teeth. Further, as shown in FIG. 3, it is not necessary that the thickness of the base material for a prosthesis 1 is uniform, and a part of said thickness may be thickened. Anyway, when the thickness of the base material for a prosthesis 1 is thickened, there is an advantage that the amount of the built resin material is little.

The resin material built on the base material for a prosthesis 1 according to the present invention is the dental resin material, in which the filler, such as a glass powder, an aerosil or the like, is contained in the polymerizable monomer being generally called as the composite resin. The resin material has the color tone approximating to the tooth, thus when an excess is generated at the time of adhering or the like, said resin material can be used by easily polishing. Further, said resin material may be the adhesive dental resin material including an adhesive monomer, a resin material for building the retainer, or the resin material having the comparatively low viscosity, according to the necessity.

Further, as shown in FIG. 6, in the base material for a prosthesis 1 according to the present invention, it is preferable that the engaging part 1b being like a hole, a projection, a groove, a rail or the like, is formed, in order to certainly connect the resin material with the base material for a prosthesis 1 after said resin material has hardened, when said material is built on the labial side (buccal side) surface part 1a.

Further, as shown in FIGS. 3, 5 and 6, in the shape that the base material for a prosthesis 1 according to the present invention has the surface 1c contacting with the mucous surface of the dental cervix, the work for forming an oral mucous surface is not necessary, and further, when the base material for a prosthesis 1 according to the present invention is used for the bridge, the resin material is hardly flowed down to the oral mucous at the time of building the resin material on the labial side (buccal side) surface part 1a during the work in the oral cavity, thus it is preferable.

For forming the bridge by using such the base material 1 for a prosthesis 1 according to the present invention, the bridge having the form like the anterior tooth, conine, molars or plural type teeth including these teeth can be made by only the work being directory carried out in the oral cavity. That is, the work, choosing the base material 1 having the form and size being suitable to the part, where the tooth is lost while the adjacent teeth being exist and no dental root being exist, arranging it at the oral cavity side from the mucous at the dental cervix of the part where the tooth is lost, forming the labial side (buccal side) surface and the occlusal surface by using the resin material such as the low viscosity dental composition resin or the like to the labial side (buccal side) surface part 1a (while using a dental-adhesive resin or carrying out the dental surface treatment according to a regular method, if necessary), and adhering and fixing to the adjacent surfaces of the adjacent tooth.

When the base material for a prosthesis 1 according to the present invention is used in this way, the dental prosthesis can be made in a short time only in the treating place, without carefully making the retainer such as a retaining tooth or the like while considering the form and structure of the dental prosthesis being made after, as done conventionally, and also without the indirectly works, such as making the gypsum model obtained by images, or making the bridge outside the oral cavity.

Further, for forming the artificial tooth for the partial denture by using the base material for a prosthesis 1 according to the present invention, the artificial tooth is made by the steps of forming the part for engaging a clasp at the adjacent teeth of both sides of the part, where the tooth is lost while the adjacent teeth of its both sides exist and no dental root exists, obtaining an images of the part including said part for engaging the clasp (the negative mold of the tooth) from the inside of the oral cavity of the patient, making the gypsum model (the reproduction of the tooth) with said images, building a gingival part adjusted to the form in the oral cavity of the patient with a wax material on said gypsum model, piercing said gingival part to form the clasp at its both sides, choosing and arranging the base material for a prosthesis 1 according to the present invention having the suitable form and size at the oral cavity side of the gingival part, forming the labial side (buccal side) surface and the occlusal surface if necessary to make the artificial tooth by using the resin material, such as the low viscosity dental composite resin or the like, to the labial side (buccal side) surface part 1a of said base material for a prosthesis 1, (where the dental-adhesive resin material is used or the dental surface is treated according to a regular method before using the resin if necessary), setting the gypsum model in the dental flask, pouring the gypsum into the oral cavity side of the gypsum model to hold the artificial tooth, taking said flask into the electric furnace after the gypsum having hardened, burning the wax pattern by heating to obtain the mold, pouring the resin for the denture base into the mold to form the gingival part, and cutting and polishing the gingival part after digging out from the gypsum. Then, the partial denture is made completely.

When the base material for a prosthesis 1 according to the present invention is used in this way, it is not necessary that the suitable artificial tooth is chosen from the artificial teeth having the various forms, sizes or color tones as done conventionally, thus the color can be regained freely according to the color of the tooth of the patient, and further, the artificial tooth having the occlusal surface or the like being suitable to the patient can be made.

As mentioned above, the base material for a prosthesis according to the present invention is the base material having the abrasion resistance and aesthetic appreciation more than equivalent to those of the conventional artificial tooth, which is used for directly forming the bridge in a short time, and for easily making the artificial tooth used for the partial denture suiting to the lacked tooth part of the patient, in the case that the making of the dental prosthesis is necessary since the tooth is lost while no dental root exists. In the case of using said base material for the bridge, the dental prosthesis having the same color tone as that of the adjacent teeth can be made in a short time only in the treating place, wherein the cutting of the healthy teeth and the careful making of the retainer while considering the form and structure of the dental prosthesis being made after as done conventionally is not necessary, thus the burden on the patient can be reduced to a minimum, and further, the making of the gypsum model obtained by the images and the indirectly making of the dental prosthesis outside the oral cavity are not necessary. Further, when the ready-made artificial tooth being suitable to said partial denture is used, said ready-made artificial tooth has very many kinds, in which the shape, the size and the color tone are different, thus the time and experience have been needed so much in order to choose what kinds of the teeth to be used. However, by using the base material for a prosthesis according to the present invention for said artificial tooth, the color can be regained freely according to the color of the tooth of the patient without such the time and effort, and further, the artificial tooth having the suitable occlusal surface or the like can be made.

In making of the bridge and the artificial tooth for the partial denture, with using the base material for a prosthesis according to the present invention, since the lingual side surface part, in which the aesthetic appreciation is not required so much, is formed beforehand, only the labial side (buccal side), in which the aesthetic appreciation is required, and the occlusal surface, which is important as the dental prosthesis, should be formed with the dental resin material, thus the time and effort can be remarkably reduced.

Further, in the case of the shape that two to four teeth are connected, the connected bridge or the artificial tooth for the partial denture can be made at once. In the case of the shape that the thickness of the lingual side surface part is almost corresponding to the thickness of an enamel in a natural tooth, the minimum strength at the time of making the bridge or the artificial tooth for the partial denture can be secured. Further, in the case of the shape having the surface contacting with the mucous surface of the dental cervix part, when the bridge is made in the oral cavity, the resin material is hardly flowed down to the mucous in the oral cavity at the time of building the resin material on the labial side (buccal side) surface part, and in the case that the engaging part connecting with the resin material built on the labial side (buccal side) surface part is formed, the resin material built on the labial side (buccal side) surface part is strongly fixed, thus it is preferably.

The base material for a prosthesis according to the present invention giving such various effects has the great value for contributing to the dental treatment.

What is claimed is,

1. A base material for a prosthesis,
wherein said material is made of a resin material, and comprises only a part having a form approximating to a lingual side surface part of the teeth being at the oral cavity side from a mucous at a dental cervix.

2. The base material for a prosthesis according to claim 1,
wherein two to four teeth are connected.

3. The base material for a prosthesis according to claim 1 or claim 2,
wherein a thickness of the lingual side surface part is 0.5 mm or more from the lingual side surface and is less than 0.5 mm from a labial surface of a teeth form being made finally.

4. The base material for a prosthesis according to any one of claim 1 and claim 3,
wherein a surface contacting with a mucous surface at the dental cervix is formed.

5. The base material for a prosthesis according to any one of claim 1 and claim 4,
wherein an engaging part (1b) connecting with the resin material built on a labial side surface (1a) is formed.
